(19) United States
(12) Patent Application Publication
(10) Pub. No.: US 2008/0001844 A1
(43) Pub. Date: Jan. 3, 2008

(54) Masking device for contactless portable object in the form of a secure document equipped with a radiofrequency device

(76) Inventors: Elias Sabbah, Valbonne (FR); Michel Leduc, Trets (FR); Georges Kayanakis, Antibes (FR)

Correspondence Address: JAMES C. LYDON, 100 DAINGERFIELD ROAD, SUITE 100, ALEXANDRIA, VA, 22314, US

(21) Appl. No.: 11/806,893

(22) Filed: Jun. 5, 2007

Related U.S. Application Data
(60) Provisional application No. 60/810,646, filed on Jun. 5, 2006.

(30) Foreign Application Priority Data
Jun. 6, 2006 (FR) 0604992
Dec. 13, 2006 (FR) 0610859

(51) Int. Cl. H01Q 1/40; H01Q 1/38

(52) U.S. Cl. 343/873

(57) ABSTRACT

A masking device (10, 100, 31, 80) for preventing remote exchange of data between a reader and a contactless object (21, 121, 41, 81) equipped with a radiofrequency device, the radiofrequency device including an antenna (22, 122, 42, 70) and a chip (24, 124, 44, 84) connected together. The masking device includes at least network of conductive lines (20, 120, 30, 70, 13) made on a planar support (11, 111, 32, 92), the device preventing the wake-up of the chip (24, 124, 44, 84) and the reading of its data when it is placed near the antenna (22, 122, 42, 82).

### TECHNICAL FIELD

The present invention concerns a peripheral device for a contactless portable object and particularly concerns a masking device for a contactless portable object in the form of a secure document equipped with a radiofrequency device.

### BACKGROUND ART

Contactless Radiofrequency Identification Devices (RFIDs) are increasingly used for identification of persons moving about in controlled access zones or transiting from one zone to another. As a result, the market for identity secure documents such as passports, identity cards or others is booming. A contactless radiofrequency device is a device made up of an antenna and a chip connected to the terminals of the antenna. The chip is usually not powered and receives its energy through an electromagnetic coupling between the antenna of the reader and the antenna of the radiofrequency device, information is exchanged between the radiofrequency device and the reader and particularly information stored in the chip that relates to the identification of the holder of the object on which the radiofrequency device is located and to his/her authorization to enter into a controlled access zone.

In this manner, passports can incorporate RFIDs to identify the passport holder. The chip memory contains information such as the identity of the passport holder, his/her country of origin, his/her nationality, visas of different countries visited, dates of entry, restrictions of movements, biometric elements, etc. In order to include the radiofrequency device in the passport, there exist several solutions that consist in either directly printing the antenna on the cover board of the passport and connecting the chip to it or using an external element known as “inlay” carrying the radiofrequency device. Whatever the solution, the radiofrequency device is incorporated either in the bottom cover board of the passport or in the top cover board. Other configurations are possible such as the insertion of the inlay, generally made of polycarbonate, in the data page, or the addition of a contactless card in a slot within the passport. In the case of an identity card, the antenna is screen printed directly on one of the layers which make up the card and the chip is connected to it. The issues are the same for control cards dedicated to accessing secure sites such as, for example, the cards used by government employees.

Access to data of the chip is made by remote electromagnetic coupling with a reader also equipped with an antenna. When the antenna of the reader is powered, an electric current flows through it, which generates an electromagnetic flow. In order to be read, the identity booklet is placed on the reader at a location designed for this purpose. Once the booklet is in place, the antenna of the booklet is crossed by electromagnetic field lines emitted by the reader; the antenna thus tuned to the same frequency as the carrier frequency of the reader receives the energy required for its power supply; electromagnetic signals can thus be transmitted to and received from the antenna of the reader; the data of the chip can thus be read. For optimal communication, the antenna of the booklet must be placed parallel to the antenna of the reader and at a distance from the reader that must be less than the minimum distance required for communication between the two antennas.

The major problem that commonly arises in contactless documents in general, and in secure documents that contain personal information of biometric or civil status type in particular, is the protection of privacy, i.e. the confidentiality of information contained in the radiofrequency device incorporated in the chip of the document. The exchange of data contained in the chip must be controllable, particularly when the secure document is not used, so that the confidential data is not read without the knowledge of the document holder. Furthermore, the simple fact that the chip wakes up or responds according to standards may result in the transmission of information that, even if it is not personal data, can provide the basis of an unauthorized traceability.

Generally, to resolve the problem mentioned, the solution consists in integrating in the secure document a system that prevents unauthorized reading of confidential data as well as the wake-up of the chip. One of the existing solutions consists in integrating in the secure document a solid mask made of conductive material so that when the mask is against the radiofrequency device, no flow from the reader can cross the antenna because the mask plays the role of a magnetic shield. As the antenna does not play its role as an antenna any more, the chip receives no power and the secure document cannot be read by the reader.

The drawback of using a mask to avoid untimely reading of a secure document resides in the fact that the attenuation of the signal between the reader and the radiofrequency device depends on the characteristics of the mask such as its thickness and its electrical conductivity, as well as the distance between the mask and the antenna of the radiofrequency device. The mask is really efficient when closest to the antenna, which means that as soon as the mask starts going further away from the antenna, its effectiveness drops significantly. Another drawback of this solution resides in the fact that passports can be detected in walk-through scanners used for safety checks in airports for example. In that case, passengers must part with their passport.

### SUMMARY OF THE INVENTION

This is why the object of the invention is to provide a device that prevents the untimely reading of data contained in a contactless portable object in the form of a secure document equipped with a radiofrequency device, which mitigates the aforementioned drawbacks.

The purpose of the invention is thus a masking device for preventing remote exchange of data between a reader and a contactless object equipped with a radiofrequency device, the radiofrequency device featuring an antenna and a chip connected together. According to a main characteristic of the invention, the masking device includes at least at least network of conductive lines made on a planar support, the device preventing the wake-up of the chip and the reading of data from the chip when it is placed near the antenna.

### BRIEF DESCRIPTION OF THE DRAWINGS

The purposes, objects and characteristics of the invention will become more apparent from the following description when taken in conjunction with the accompanying drawings in which:

FIG. 1 represents the masking device according to a first embodiment of the invention,

FIG. 2 represents an identity booklet type secure document in which a masking device according to the first embodiment of the invention is integrated,

FIG. 3 represents the masking device according to a second embodiment of the invention,

FIG. 4 represents the insertion of the masking device according to the second embodiment of the invention in an identity booklet,

FIG. 5 represents the identity booklet equipped with the masking device according to the second embodiment of the invention,

FIG. 6 represents the masking device according to a third embodiment of the invention,

FIG. 7 represents the masking device according to a third embodiment of the invention relating to a case for a card or a badge,

FIG. 8 represents the masking device according to a variant of the first embodiment of the invention,

FIG. 9 represents the masking device according to another variant of the second embodiment of the invention,

FIG. 10 represents the masking device according to the fourth variant of the second embodiment of the invention,

### DETAILED DESCRIPTION OF THE INVENTION

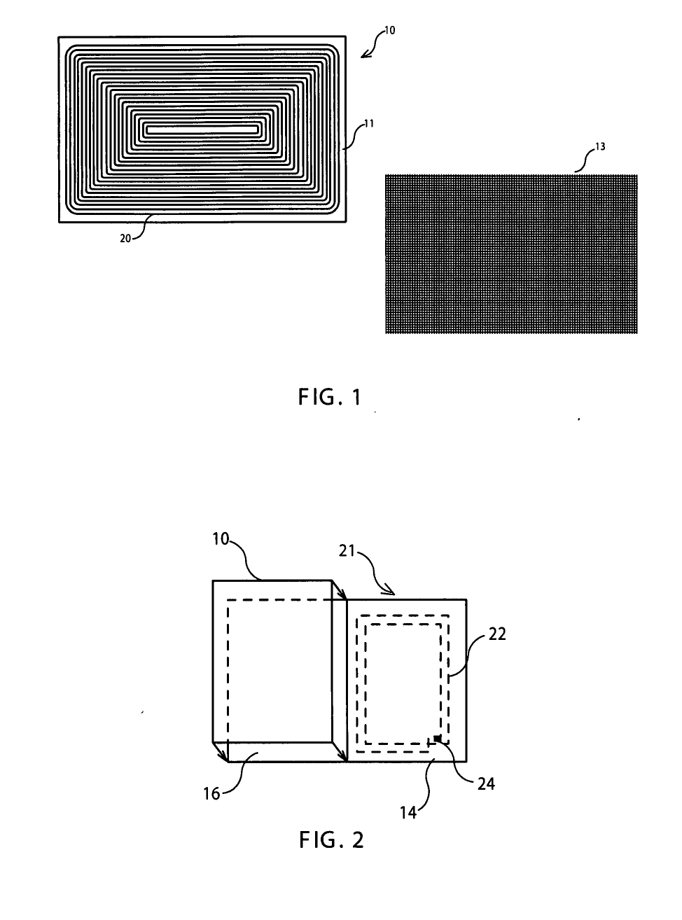

According to FIG. 1, a set of concentric turns or closed loops 20 is produced on a support 11 in order to form a masking device 10 according to the first embodiment of the invention. The number and sizes of the turns are determined according to the specific needs mentioned farther in this description. The support 11 is preferably made of paper or synthetic printable material. The turns are made by screen printing, flexography, rotogravure, offset printing or inkjet printing with epoxy type conductive ink loaded with conductive particles such as silver or gold particles, or with a conductive polymer.

According to FIG. 2, the masking device 10 defined above is integrated on the cover of a secure document such as an identity booklet 21. The identity booklet 21 comprises the radiofrequency device made up of the antenna 22 and the chip 24 connected together and placed, for example, on the bottom cover board 14 of the front cover of the identity booklet 21, while the masking device is positioned and glued onto the top cover board 16 of the cover of the identity booklet 21. A positioning constraint for the masking device with respect to the radiofrequency device being that the masking device must be supported on a part of the identity booklet that can move with respect to the part supporting the radiofrequency device. The masking device 10 is fixed on the booklet cover by gluing. Preferably, the glue that is used is a glue that, once dry, becomes insoluble in water. When the quire of inside pages is attached by sewing on the cover, the front and back flyleaves will be laminated on the masking device 10 and on the bottom cover board of the booklet cover respectively. The masking device made up of the set of turns 20 can be printed directly on the cover of the booklet or on a page of the booklet. The support 11 has preferably the size of the identity booklet 21 so that the size of the masking device 10 is the same than that of the identity booklet 21. The size of the support 11 can also be slightly smaller than that of the identity booklet without deviating from the scope of the invention. The masking device could as well be located on one of the pages of the inside quire, for example the page that is against the front cover board containing the radiofrequency device, so that the masking device is located as close as possible to the radiofrequency device antenna 22 when the booklet is in the closed position.

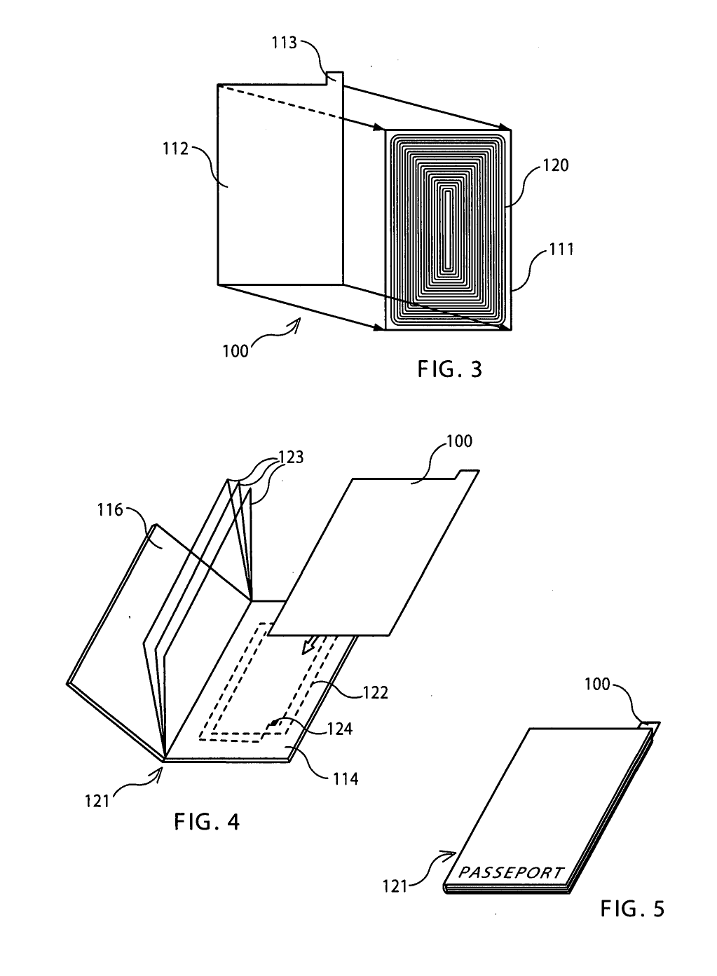

A second embodiment of the masking device according to the invention is shown in FIG. 3. Like in the first embodiment, a set of concentric turns or closed loops 120 is made on a planar support 111. The turns are made by screen printing, flexography, rotogravure, offset printing or inkjet printing with epoxy type conductive ink loaded with silver or gold particles or with a conductive polymer. Preferably, the support 111 has the same size as the closed passport. A layer 112 is glued onto the support 111 on the side of the turns 120 so as to protect them and form a removable masking device 100. The layer 112 is made up of two parts: one main part having the size of the support 111, and one part 113 located preferably on a short edge of the support 111, in line with the extension of one of the long edges of the support. The part 113 forms a gripping and positioning tab. The layer 112 and the support 111 are made of paper, teslin-type synthetic paper or PVC. The device 100 presents at least one printable face.

The masking device thus formed is designed to be placed inside an identity booklet 121 including a radiofrequency device comprising an antenna 122 and a chip 124 connected together and arranged, for example, on the bottom cover board 114 of the front cover of the identity booklet 121. The radiofrequency device shown in dotted lines in FIG. 4 is generally hidden under the bottom flyleaf laminated onto the bottom cover board 114. In order to be used, the masking device is placed in the booklet so as to be near, and preferably as close as possible to, the radiofrequency device, thus preferably between the last page that makes up the quire of inside pages 123 of the booklet and the bottom flyleaf. The masking device is placed so that its edges are aligned with those of the identity booklet. In this manner, only the gripping and positioning tab 113 projects from the booklet when the masking device is in place inside the booklet in closed position, as shown FIG. 5. In comparison with the masking device according to the first embodiment of the invention, the device 100 has the advantage of being removable so that it can be installed or removed by the holder of the identity booklet as needed. The gripping and positioning tab 113 facilitates the insertion of the masking device into the identity booklet and the removal of the masking device into the identity booklet. For example, in order to protect the data contained in the chip of his/her identity booklet, the user follows a tree-step procedure: first, he/she places the masking device 100 between the last page and the cover page edge-to-edge with the booklet and with the gripping and positioning tab 113 located in the upper right corner; then, when the booklet is to be checked, the user removes the masking device before handing over his/her booklet to the inspector; lastly, after the checking operation, the user puts the masking device back in his/her identity booklet. This three-step procedure can be described and printed on the masking device 100, on the layer 112 or on the back of the device so as to present the directions for use of the device. It is also possible to print the logo of the applicant or dealer.

The masking device according to the second embodiment of the invention does not change the current manufacturing processes for the identity booklets equipped with a radiofrequency device since it is a distinct removable item.

The identity booklet provided with its masking device prevents unauthorized reading of the confidential data contained in the chip 124. In this manner, the holder of the identity booklet equipped with its masking device is shielded against any untimely reading of his/her personal data. The operation of the masking device is explained further in the description.

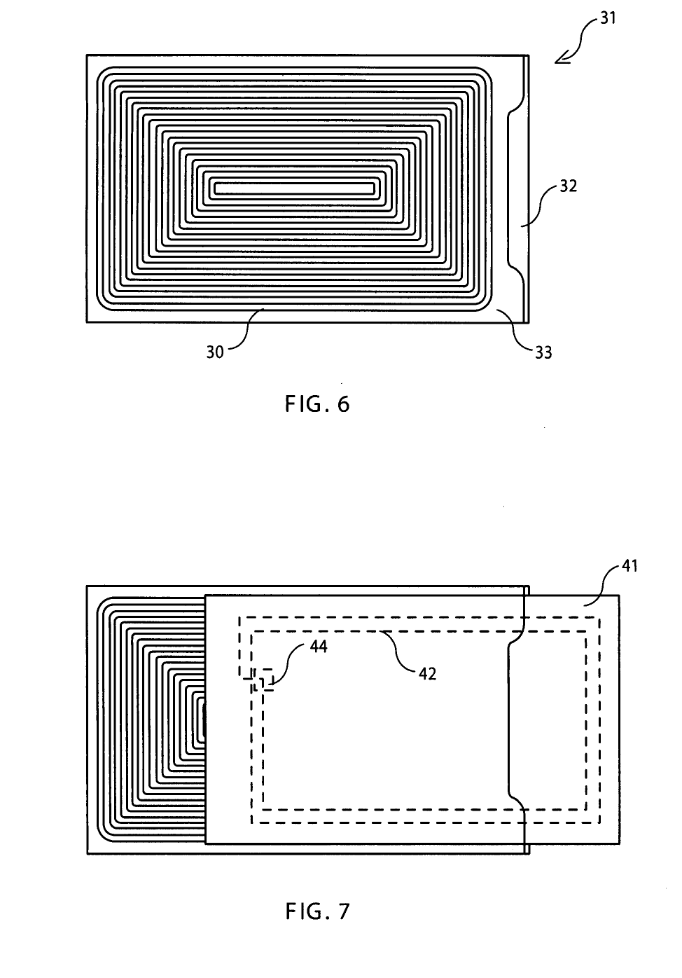

A third embodiment is shown in FIG. 6, in which the masking device forms an integral part of a case 31 for a credit card, a badge or a contactless identity card. The case is made by molding and is made up of two walls 32 and 33 separated by a distance that is sufficient to let the card pass through. The masking device is built into one of the two walls of the case so that the concentric turns 30 are flush with the surface located inside the case. The size of the largest of the turns 30 is as large as possible. The masking device is built into the wall, for example, during the molding step or the masking device is printed on a planar support which is then glued on the surface inside the case on one of the two walls 32 or 33. The planar support can be made of paper.

The case or the masking device 31 can receive a badge or a contactless card 41 including a radiofrequency device, that is to say a chip 44 and an antenna 42 connected together and designed to exchange data with a reader. When a card 41 is introduced in the case, as shown in FIG. 7, the surface area defined by the antenna 42 is entirely opposite the surface area of the turns 30. The reading of data contained in the chip 44 becomes impossible.

When the booklet 21, the booklet 121 equipped with the masking device 10, 100, or the case 31 provided with the card 41 enters the field of the reader, since the turns 20, 120 or 30 are all sensitive to a magnetic field, they generate an electromagnetic field volume containing the electromagnetic field volume generated by the antenna 22, 122 or 42 so that the amplitude of the field generated by the turns 20, 120 or 30 of the masking device significantly attenuates the amplitude of the field generated by the antenna 22, 122 or 32 of the radiofrequency device. The radiation of the assembly made up of the radiofrequency device and the masking device is then attenuated to the point where the chip 24, 124 or 44 becomes invisible. This effect occurs when the masking device is situated near the antenna and is optimal when the masking device antenna is parallel to the antenna of the radiofrequency device.

In this configuration, a strong coupling is obtained between the masking device 10, 100, and 31 and the radiofrequency device 21, 121, and 41 due to the identical shape of the turns 20, 120, 30 and the turns 22, 122, 42 of the two devices. In addition, the turns 20, 120, and 30 have, on the one hand a very low electrical resistance due to their small lengths, which makes them a good magnetic field receiver, and on the other hand, a very high resonance frequency due to the low value of the capacitance and inductance of the turns (the resonance frequency being inversely proportional to the inductance and the capacitance). The radiofrequency device 21, 121, and 41 tuned to the frequency of 13.56 MHz forms with the turns 20, 120, and 30, with which it is strongly coupled, a set whose resonance tends towards a value that is largely greater than 13.56 MHz (generally greater than 25 MHz) and whose quality factor tends towards zero. Since the antenna of the radiofrequency device is no longer tuned to that of the reader, the exchange of data between the contactless portable object and the reader is impossible as the radiofrequency device cannot be detected by the reader. For example, in the case of the identity booklet, this effect occurs when the booklet is closed so that the masking device is then situated parallel to the antenna 22, 122 and against it. Regarding the case, this effect occurs when the contactless card is fully inserted in the case. The distance between the antenna 22, 122 or 42 and the turns 20, 120 or 30 then being in the order of one millimeter or even one tenth of a millimeter. The smaller the distance between the antenna 22, 122 or 42 and the turns 20, 120 or 30, the more the radiation of the assembly decreases. At a certain distance, the attenuation is such that the communication between the reader and the booklet or the contactless card becomes impossible. The antenna of the contactless portable object equipped with the masking device according to the invention, be it the identity booklet or the contactless smart card, no longer plays its role as an antenna, the chip is not energized and the contactless portable object can only be read by an adapted radiofrequency reader.

In order to optimize the masking device according to the invention in terms of efficiency and cost, the sizing and the number of turns 20, 120, and 30 can be determined according to the sizing of the turns of the antenna 22, 122 or 42 in the radiofrequency devices included in the booklet 21 or 121 or in the card 41.

The dimensions and size of concentric turns 20, 120 or 30 preferably resemble the size and dimensions of the turns forming the antenna 22, 122 or 42. The size and dimensions of the antenna relate to the size of each turn, the distance between the turns, and the width of turns. This is why the number of turns of the masking device can be as large as possible so that small antennas are also “covered”.

However, the size of the turns of the masking devices according to all of the embodiments can be predetermined according to the size and location of the antenna of the radiofrequency device when the latter are known in advance. In this manner, the efficiency and the cost of the masking device can be optimized. A first step consists in positioning the center of the turns 20, 120, and 30 so that it coincides with the center of the turns of antennas 22, 122, and 42 when the device is in its operational position. For each embodiment, the operational position corresponds to the following position: for the identity booklet 21, it is when the masking device is glued onto the booklet cover board; for the identity booklet 121, it is when the masking device 100 is inserted between the lower cover and the last page of the booklet so that its edges are aligned with the edges of the identity booklet; for the contactless smart card 41, it is when the card is fully inserted in the case 31. A second step consists in making the turns 20, 120 or 30 of the masking devices so that their width is equivalent to that of the turns of the antennas 22, 122, and 42. A third step consists in having the minimal distance between the turns 20, 120, and 30 respectively equivalent to the minimal distance between the turns of the antennas 22, 122, and 42. The second and third steps can be advantageously performed when the material of the turns 20, 120, and 30 is equivalent respectively to that of the turns 22, 122, and 42, for example conductive ink. When the second and third steps are performed, it is essential that the number of the turns 20, 120 or 30 is greater than or equal to the number of turns of the antennas 22, 122, and 42. The best results are obtained when the surface area covered by the turns of the antennas 22, 122 or 42 is completely facing the surface area covered by the concentric turns 20, 120 or 30 when the identity booklet is closed and when the card 31 is inserted in the badge carrier 31. In order to ensure good results, it is better to choose the size of the concentric turns so that the surface area covered by the turns 20, 120, and 30 is greater than the areas covered by the turns of antennas 22, 122, and 42. The surface area covered by the turns is to be interpreted as the area delimited by the largest and the smallest of the turns located between these turns.

In order to support any type of radiofrequency devices regarding the size of the antenna turns and the number of turns, the antenna of the masking device is as large as possible and the number of turns is as high as possible so that the turns 20, 120, and 30 fully cover the support 11, 111, and 31. The turns 20, 120 or 30 of the masking device are preferably spaced out from one another by a distance between 0.1 and 0.6 millimeters and the inter-turn distance is preferably uniform over all the turns. The width of the turns is also between 0.1 and 0.6 mm and all turns are preferably of the same width.

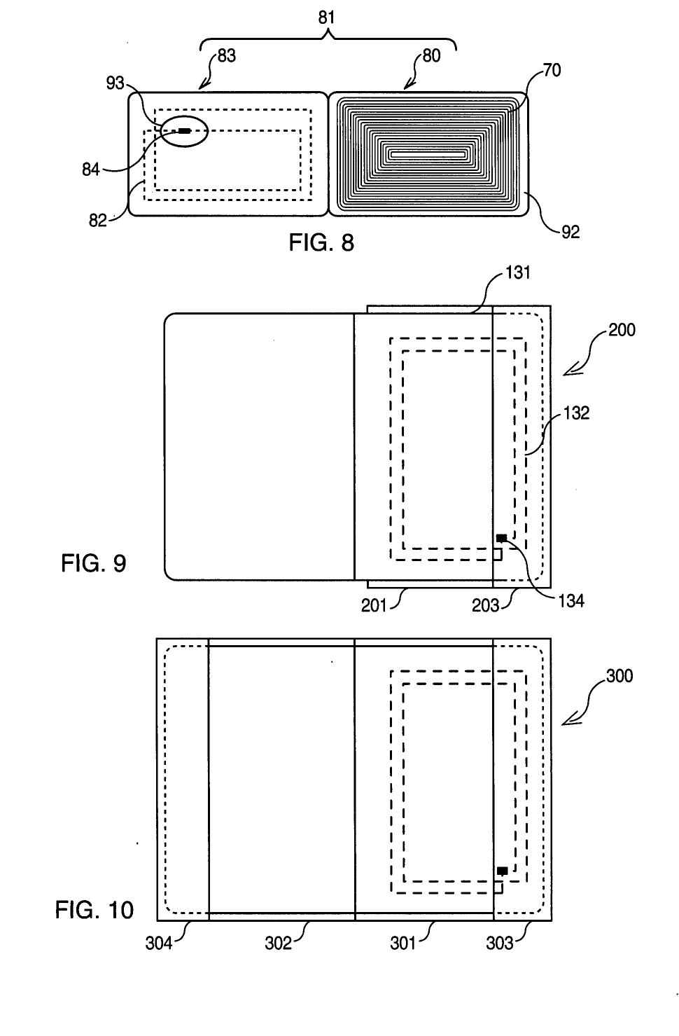

According to a variant of the first embodiment of the invention shown in FIG. 8, the contactless portable object 81 is of the smart card type or contactless ticket type. The masking device 80 including a set of turns 70, having the size of a smart card, is attached to the contactless smart card 81 by one edge of the card. In this manner, the only thing to do in order to fulfill the masking operation is folding the device onto the card. The masking device is preferably attached to the card by its short edge so that, when it is an hybrid or “combi” card, that is to say a card that can operate both with and without contact thanks to an electronic unit 83, the card can still be used in a reader provided with a slot designed for the reading of “contact cards”.

According to a variant of the second embodiment of the invention, the masking device takes the form of a smart card size ticket. In this manner, the masking device can be slid behind a contactless card, for example in its location in a wallet.

According to a variant of the second embodiment of the invention, the masking device takes the form of a self-adhesive label that can be placed behind a contactless card in order to provide it with a temporary protection or protect it in case it is shipped by mail. In order to have the card operative again, all it needs is remove the label.

According to a third variant of the second embodiment of the invention shown in FIG. 9, the masking device 200 for the identity booklet is made on a support 201 whose size is slightly greater than that of the identity booklet and has a flap 203 in the manner of an exercise-book cover so as to trap the cover 131 of the booklet containing the radiofrequency device 134. The turns of the masking device, not shown in Figure, are made in the same manner as the masking device 100 previously described. Unlike the masking device 100, in order to make the device 200 operative, the latter has to be placed on the other side of the booklet cover, that is to say on the outside.

According to a fourth variant of the second embodiment of the invention, not far from the third one, shown in FIG. 10, the masking device 300 is a support 301, 302 having the size of a whole exercise-book cover, this size being slightly greater than that of the open booklet, hence with two flaps 303 and 304. In order to make the masking device operative, the two covers of the identity booklet are slid in the two flaps. In order to make the masking operative, the face 301 of the masking device 300 containing a set of concentric turns similar to the concentric turns of the device 100 must be placed against the radiofrequency device of the booklet. A second set of concentric turns can be made on the second face 302 of the masking device 300. This causes the identity booklet to become “invisible” whatever its orientation in relation to the reader.

According to a variant of the invention, the concentric turns or closed loops 20, 120, 30 or 70 can be replaced with a grid array 13 as shown in FIG. 13. Such a grid array 13 is made up of two sets of conductive “lines” parallel to each others, and the lines of the first set are preferably perpendicular to the lines of the second set. The thickness of each line is between 0.1 and 0.5 mm and is preferably equal to 0.3 mm, and the space between the lines is between 0.3 and 0.8 mm, and is preferably equal to 0.5 mm. The concentric turns or closed loops 20, 120, 30 or 70, or the grid array 13 that possibly replaces them, form a network of conductive lines 20, 120, 30 or 70. Furthermore, the grid array 13 forms (as the set of concentric turns 20, 120 30 and 70) a set of closed loops. That way, each mesh of the grid array is a closed loop.

The turns (or grid array 13) 20, 120, 30 or 70 can also be made of aluminum by using photoetching or electro-deposition.

1-18. (canceled)

19. A masking device for preventing remote exchange of data between a reader and a contactless portable object equipped with a radiofrequency device, the radiofrequency device comprising an antenna and a chip connected together,
characterized in that it includes at least a network of conductive lines made on a planar support, said device preventing the wake-up of the chip and the reading of its data when it is placed near said antenna.

20. The masking device according to claim 19, in which said planar support is supported by a part of the contactless portable object that can be moved in relation to the part of the object that supports the radiofrequency device.

21. The masking device according to claim 19, characterized in that the contactless portable object equipped with a radiofrequency device is a secure document such as an identity booklet.

22. The identity booklet according to claim 21, in which said planar support is glued onto the top cover board of the identity booklet.

23. The masking device according to claim 19, characterized in that it is made on a removable support so that, when placed inside the identity booklet, with its edges aligned with those of the identity booklet, the masking function is activated.

24. The masking device according to claim 23, including at least one printable face.

25. The identity booklet according to claim 24, in which the directions for use of the device are printed on one face of the device.

26. The masking device according to claim 19, built into a case for contactless smart card or badge.

27. The masking device according to claim 25, characterized in that it includes a gripping and positioning tab designed to facilitate its insertion into and its removal from the identity booklet.

28. The masking device according to claim 27, characterized in that it takes the form of a smart card size ticket.

29. The masking device according to claim 27, characterized in that it takes the form of a self-adhesive label that can be placed behind a smart card.

30. The masking device according to claim 20, characterized in that it takes the form of a support attached to a smart card by one edge of the card, thus enabling it to be folded onto the card in order to fulfill the masking function.

31. The masking device according to claim 30, characterized in that the edge used for attachment is the short edge of the card.

32. The masking device according to claim 19, in which the network of conductive lines is a set of turns or concentric closed loops.

33. The masking device according to claim 19, in which said network of conductive lines is a grid array.

34. The masking device according to claim 32, in which the surface area delimited between the largest and the smallest concentric turns is located opposite the surface area delimited between the largest and the smallest turns of antenna respectively when the identity booklet is in the closed position and when the card is inserted in the badge carrier.

35. The masking device according to claim 19, in which the conductive lines are obtained by printing with a conductive ink.

36. The masking device according to claim 19, in which the conductive lines are made of aluminum.
